(19) United States
(12) Patent Application Publication
(10) Pub. No.: US 2011/0242605 A1
(43) Pub. Date: Oct. 6, 2011

(54) IMAGE FORMING APPARATUS, METHOD FOR CONTROLLING THE SAME, AND PROGRAM

(75) Inventor: Yuichi Hasama, Kawasaki-shi (JP)

(73) Assignee: CANON KABUSHIKI KAISHA, Tokyo (JP)

(21) Appl. No.: 13/132,392

(22) PCT Filed: Feb. 18, 2010
(86) PCT No.: PCT/JP2010/001021

§ 371 Date: Jun. 2, 2011

(30) Foreign Application Priority Data
Feb. 19, 2009 (JP) 2009-036908

(51) Int. Cl. G06K 15/00

(52) U.S. Cl. 358/1.15

(57) ABSTRACT

An image forming apparatus which outputs an image based on a print job received from an information processing apparatus includes a determining unit configured to determine whether a received print job is generated by an information processing apparatus which has a license for an additional drawing function when the received print job includes print data of an additional drawing for printing the additional drawing on a print target document, and a control unit configured to perform control to output an image by combining print data of the print target document included in the print job with the print data of the additional drawing when the determining unit determines that the received print job is generated by the information processing apparatus which has the license.

### TECHNICAL FIELD

The present invention relates to an image forming apparatus, a method for controlling the image forming apparatus, and a program.

### BACKGROUND ART

A new function can be additionally imparted to a printer driver installed in a printer connected to a host computer by further installing a functionality enhancement module therein.

A conventional example of the additional function is a copy-forgery-inhibited pattern (for example, see Japanese Patent Application Laid-Open No. 2001-197297). An image with the copy forgery inhibited pattern is characterized in that just a simple pattern or an ordinary background image to the human eyes in an original of then image (printed matter directly outputted from a printer) manifests itself as a given character or image when the image is duplicated. This characteristic can effectively prevent, for example, the use of unwanted duplication of the printed matter. The copy-forgery-inhibited pattern function can be forcibly added to the printed material by a PC administrator, and a potential way to use the copy-forgery-inhibited pattern is to include the pattern in all of printouts in a workplace. Thus, the copy-forgery-inhibited pattern function now plays an important role in prevention of information leak. Thus, there are administrators who request that it would be mandatory for all of users to use the copy-forgery-inhibited pattern function.

The functionality enhancing technique for the printer driver thus offers an additional value to users. Thus, it is discussed to supply function enhancement modules and programs for additionally installing the modules in the form of paid software. To bring such a post-production functionality enhancement into practice, it is required to further incorporate a requirement to control availability of the functionality enhancing technique for the printer driver so that a commercial value of the software is protected.

Japanese Patent Application Laid-Open No. 2006-099747 discusses a technique for preventing unlimited installation of a program module configured to enhance functions of a printer driver. The technique discussed in Japanese Patent Application Laid-Open No. 2006-099747 controls determination of whether data or a functionality enhancement module necessary for operating the program module configured to enhance the printer driver functionality is included in an installation set to be additionally installed.

### CITATION LIST

### Patent Literature

PTL 1: Japanese Patent Application Laid-Open No. 2001-197297
PTL 2: Japanese Patent Application Laid-Open No. 2006-099747

### SUMMARY OF INVENTION

According to an aspect of the present invention, an image forming apparatus which outputs an image based on a print job received from an information processing apparatus includes a determining unit configured to determine whether a received print job is generated by an information processing apparatus which has a license for an additional drawing function when the received print job includes print data of an additional drawing for printing the additional drawing on a print target document, and a control unit configured to perform control to output an image by combining print data of the print target document included in the print job with the print data of the additional drawing when the determining unit determines that the received print job is generated by the information processing apparatus which has the license.

Other features and advantageous of the present invention will be apparent from the following description taken in conjunction with the accompanying drawings, in which like reference characters designate the same or similar parts throughout there of.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a system to which an image forming apparatus according to the present invention is applicable.

FIG. 2 illustrates a configuration for printing processing executed by a host computer and a printer.

FIG. 3 is a flow chart illustrating printing processing executed by a printer driver according to a first exemplary embodiment of the present invention.

FIG. 4 illustrates an example of a document to be printed (print target document).

FIG. 5 illustrates an example of unique information.

FIG. 6 illustrates an example of an additional drawing.

FIG. 7 illustrates an example of a print job according to the first exemplary embodiment.

FIG. 8 is a flow chart illustrating printing processing executed by a printer according to the first exemplary embodiment.

FIG. 9 illustrates an example of a license database (DB).

FIG. 10 illustrates an example of a print result of a document with an additional drawing.

FIG. 11 is a flow chart illustrating printing processing executed by a printer driver according to a second exemplary embodiment of the present invention.

FIG. 12 illustrates an example of a print job according to the second exemplary embodiment.

FIG. 13 is a flow chart illustrating printing processing executed by a printer according to the second exemplary embodiment.

FIG. 14 is a flow chart illustrating printing processing executed by a printer driver according to a third exemplary embodiment of the present invention.

FIG. 15 illustrates an example of a print job according to the third exemplary embodiment.

FIG. 16 is a flow chart illustrating printing processing executed by a printer according to the third exemplary embodiment.

FIG. 17 is a flow chart illustrating printing processing executed by a printer driver according to a fourth exemplary embodiment of the present invention.

FIG. 18 illustrates an example of a warning message with an additional drawing according to the fourth exemplary embodiment.

FIG. 19 illustrates an example of a print job according to the fourth exemplary embodiment.

FIG. 20 is a flow chart illustrating printing processing executed by a printer according to the fourth exemplary embodiment.

### DESCRIPTION OF EMBODIMENTS

Various exemplary embodiments, features, and aspects of the invention will be described in detail below with reference to the drawings.

### Example 1

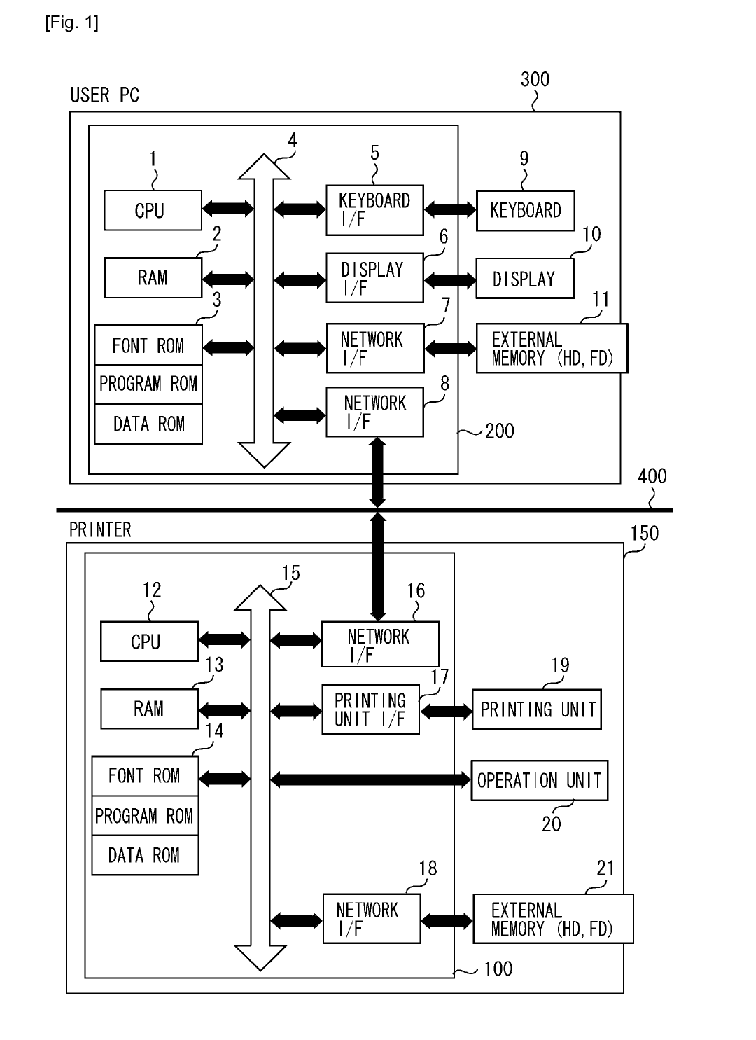

FIG. 1 is a block diagram illustrating a system to which an image forming apparatus according to the present invention is applicable. Unless stated otherwise, the present invention can be applied to either a system which includes a single device or a system which includes a plurality of devices as far as functions according to the present invention are realized. The present invention is also applicable to a system which executes processing via connection over a network, such as a local area network (LAN) or wide area network (WAN), as far as the functions according to the present invention are realized unless stated otherwise.

In FIG. 1, a host computer (information processing apparatus) 300 is a user personal computer (PC). The host computer 300 is provided with a central processing unit (CPU) 1. The CPU 1 processes a document including various parts such as diagrams, images, characters and tables (including spreadsheet) based on a program read-only memory (ROM) of a ROM 3 or a document processing program stored in an external memory 11. The CPU 1 comprehensively controls each of devices connected to a system bus 4.

The program ROM of the ROM 3 or the external memory 11 stores, for example, an operating system program (hereinafter, abbreviated as OS) which is a control program for the CPU 1. Further, font data used for processing the document or the like is stored in a font ROM of the ROM 3 or the external memory 11. Further, various types of data used for processing the document are stored in a data ROM of the ROM 3 or the external memory 11.

A random access memory (RAM) 2 serves as a main memory and a work area of the CPU 1. A keyboard interface (I/F) 5 controls key inputs from a keyboard 9 and a pointing device not illustrated. A display I/F 6 controls display on a display 10.

An external memory I/F 7 controls an access to the external memory 11 such as a hard disc (HD) or a floppy disc (FD). The external memory 11 stores, for example, a boot program, various types of applications, font data, user files, edited files, and a printer driver. A network I/F 8 controls a communication with a printer 150 (image forming apparatus) via a network 400.

The CPU 1 performs rasterization processing of an outline font to a display information RAM provided on the RAM 2 to enable what-you-see-is-what-you-get (WYSIWYG) display on the display 10. The CPU 1 opens various registered windows based on a command which is inputted by a mouse cursor (not illustrated) on the display 10 and executes various types of data processing. When a user executes printing, the user opens a print setup window to select a printer and set a printing method in the printer driver including selection of a print mode.

The printer 150 includes a printer CPU 12. The CPU 12 outputs an image signal as output information to a printing unit (printer engine) 17 connected to a system bus 15 based on a control program stored in a program ROM of a ROM 14 or an external memory 21.

The program ROM of the ROM 14 stores the control program for the CPU 12. A font ROM of the ROM 14 stores font data or the like to be used when the output information is generated. A data ROM of the ROM 14 stores information used on the host computer when the printer is not equipped with the external memory 21 such as a hard disc.

The CPU 12 can communicate with the host computer 300 via the network I/F 16 and the network 400 and notify the host computer 300 of information in the printer.

A RAM 13 serves as a main memory and a work area of the CPU 12. The RAM 13 is configured to extend its memory capacity by using an option RAM connected to an extension port not illustrated. The RAM 13 is used as a rasterization area for the output information, a storage area for environmental data, and non-volatile random access memory (NVRAM).

An external memory I/F 18 controls an access to the external memory 21 such as a hard disc (HD) as described above or an integrated circuit (IC) card. The external memory 21 is connected to the external memory I/F 18 as an optional device for storing font data, form data, and an emulation program. The external memory 21 to be connected is not limited to one. At least two or more external memories may be connected in which an option font card in addition to built-in fonts and a program for interpreting different printer control languages are stored. Further, the external memory 21 may include an NVRAM (not illustrated) so that printer mode setup information from an operation unit (operation panel) 20 is stored in the NVRAM. The operation unit 20 is equipped with an operation switch, a light-emitting diode (LED) display, and a liquid crystal display (LCD), and receives a user's operation. The network 400 may be connected with a plurality of host computers 300 and a plurality of printers 150. The host computer 300 and the printer 105 may be directly connected to each other by, for example, a USB cable.

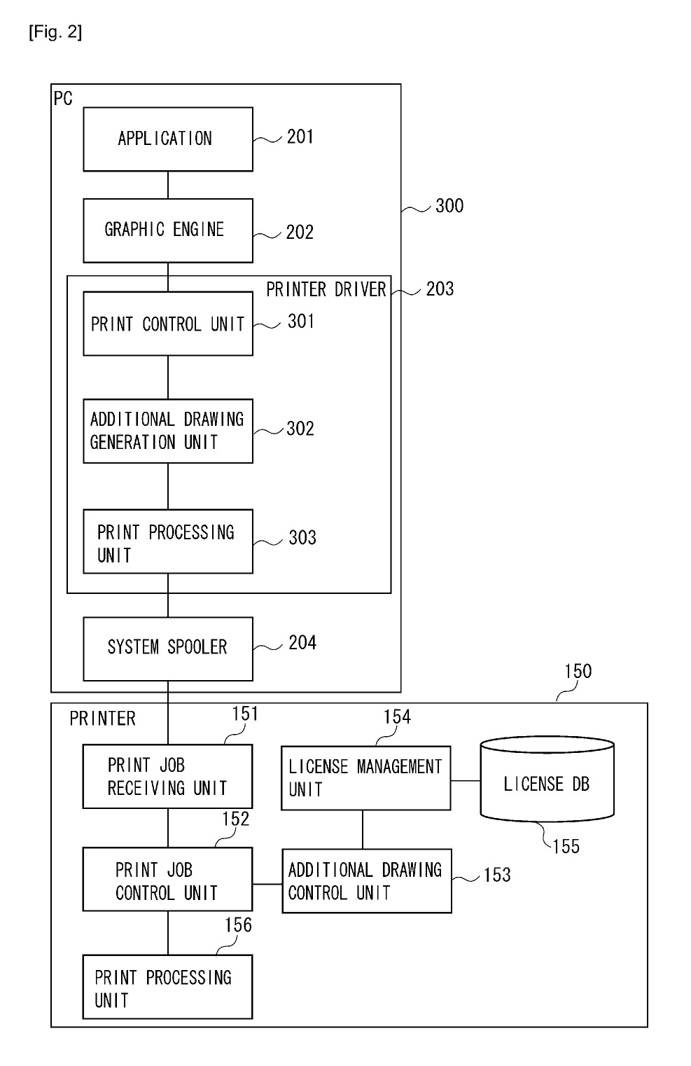

FIG. 2 illustrates configuration for executing printing processing executed by the host computer 300 and the printer 150 of FIG. 1. The host computer 300 includes an application 201, a graphic engine 202, a printer driver 203, and a system spooler 204, each stored in the external memory 11 in the form of a file. They are each a program module to be loaded into the RAM 2 by the operation system (OS) and another module which uses the module and to be executed by the CPU 1. These program modules (particularly, the application 201 and printer driver 203) can be added to the external memory 11 such as FD, a compact disc ROM (CD-ROM, not illustrated), or the external memory 11 such a HD via the network 400.

The application 201 stored in the external memory 11 is loaded into the RAM 2 and executed by the CPU 11. When a user causes the printer 150 to perform printing via the application 201, the user also uses the graphic engine 202 similarly loaded into the RAM 2 which is ready to be executed by the CPU 1 to output the data (drawing).

The graphic engine 202 loads the printer driver 203 provided for each printer into the RAM 2 from the external memory 11, and converts an output of the application 201 into a printer control command by using the printer driver 203. The converted printer control command is outputted as a print job to the printer 150 via the network 400 and the system spooler 204 which is loaded into the RAM 2 by the OS.

In the present exemplary embodiment, the printer drive 203 includes a print control unit 301, an additional drawing generation unit 302, and a print processing unit 303. The print control unit 301 controls print data. The additional drawing generation unit 302 implements an additional drawing function for generating an additional drawing. The print processing unit 303 processes the print data. The additional drawing generation unit 302 is installed in the host computer 300 as an additional function of the printer driver 203.

The printer 150 includes a print job receiving unit 151, a printing job control unit 152, an additional drawing control unit 153, a license management unit 154, and a license DB 155. The print job receiving unit 151, the printing job control unit 152, the additional drawing control unit 153, and the license management unit 154 are each a program module to be loaded into the RAM 13 from the ROM 14 by the OS and another module which uses the module to be executed by the CPU 12. The license DB 155 is built on the external memory 21.

The print job receiving unit 151 receives a print job from the host computer 300. The print job control unit 152 controls the print job. The additional drawing control unit 153 controls an additional drawing. The license management unit 154 manages a license of the additional drawing function that is registered in the license DB 155.

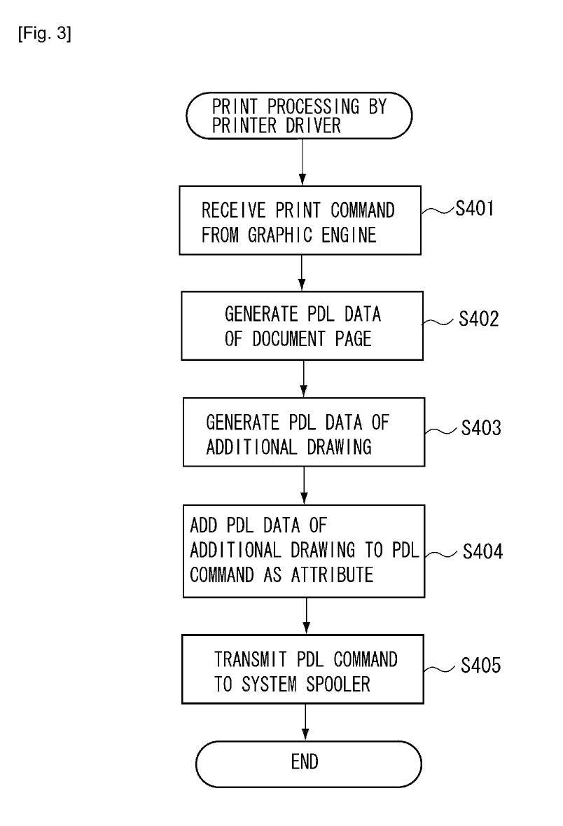

Hereinafter, printing processing executed by the printer driver 203 according to a first exemplary embodiment of the present invention will be described referring to a flow chart illustrated in FIG. 3. FIG. 3 is a flow chart illustrating the printing processing executed by the printer driver 203 according the first exemplary embodiment. A program of the printer driver 203 associated with the processing illustrated in the flow chart is stored in the HD 11 of the computer and read by the RAM 2 to be executed by the CPU 1.

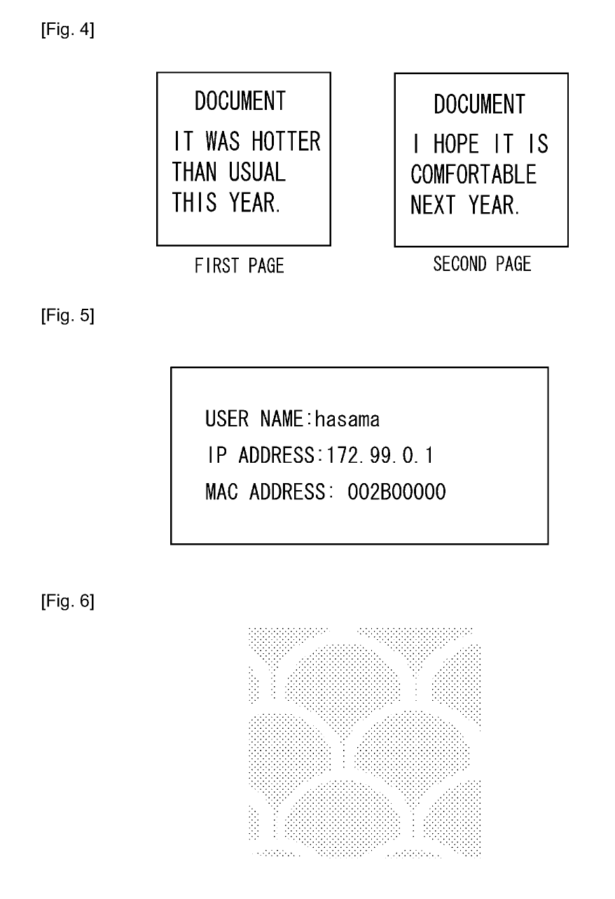

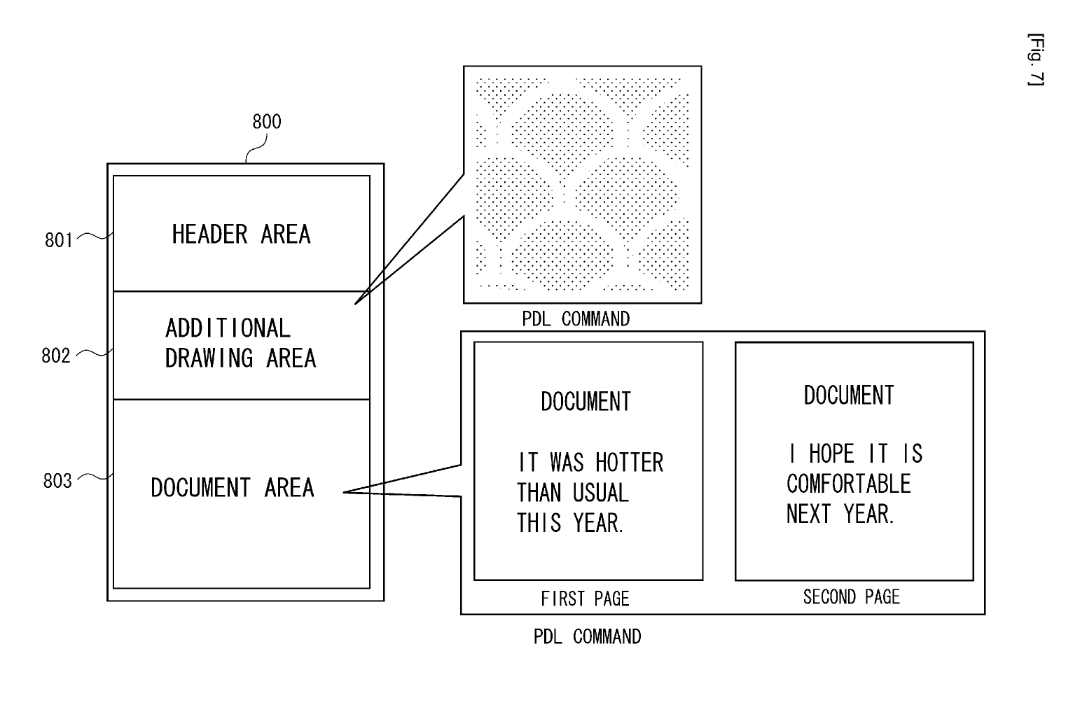

FIG. 4 illustrates an example of a document to be printed (print target document) according to the present exemplary embodiment. The description is given below on condition that the additional drawing function is installed in the printer driver 203 according to the present exemplary embodiment as an additional function, so that an additional drawing is forcibly added to a printed matter to avoid information leak from the printed matter. Further, the printer driver 203 may be configured such that a user can set whether the additional drawing function is used and which additional drawing will be selected by operating a printing setup screen of the printer driver 203. In the present exemplary embodiment, a copy-forgery-inhibited pattern illustrated in FIG. 6 is described as an example of the additional drawing. Another possible example of the additional drawing is form information which is typical drawing data such as background or logo. When a license for the additional drawing is valid, for example, form overlay print is performed, in which the form information and print data are overlaid and then printed by each page. When the license for the additional drawing is invalid, printing processing similar to the print of the copy-forgery-inhibited pattern is selected.

When printing processing for printing a document of FIG. 4 is executed via the application 201, the printer driver 203 is called via the graphic engine 202, and the processing illustrated in the flow chart in FIG. 3 starts.

In step S401, the print control unit 301 of the printer driver 203 receives print data of the document (print target document) and a print command from the graphic engine 202.

In step S402, the print control unit 301 converts the print data of the document received in S401 into a print command called “Page Description Language (PDL)” (print data printable by the printer 150) to create a print job (FIG. 7, described later). The print control unit 301 includes information by which each user can be identified in the print job as attribute data other than the conventional print command. In the present exemplary embodiment, as illustrated in FIG. 5, the print control unit 301 includes in the print job, for example, such unique information as “user name”, “MAC address” and “IP address” obtained from the host computer that executes the printing as the attribute data of the print job.

FIG. 5 illustrates an example of the unique information according to the present exemplary embodiment. In the unique information of FIG. 5, the “user name”, “MAC address” and “IP address” are illustrated as information by which the user and the host computer can be uniquely identified. However, the information is not limited thereto. For example, the “user name” and “MAC address” alone may be used, or the “user name” and configuration information of each device constituting the host computer may be used as the information. The unique information may be information that can uniquely identify the host computer, for example, the “MAC address” alone or configuration information of each device constituting the host computer may be used as the information.

In step S403, the additional drawing generation unit 302 generates a PDL command of the additional drawing. In the present exemplary embodiment, a PL command corresponding to the copy-forgery-inhibited pattern illustrated in FIG. 6 is generated as an example of the additional drawing.

FIG. 6 is an example of the additional drawing according to the present exemplary embodiment. In step S404, the print processing unit 303 adds the PDL command of the additional drawing generated in step S403 to the print job generated in step S402 (FIG. 7) as the attribute data.

FIG. 7 is an example of the print job to which the PDL command of the additional drawing is added as the attribute data according to the first exemplary embodiment of the present invention. In FIG. 7, a Header area 801 stores the document print command received in step S401 and the unique information of the host computer added in step S402 (FIG. 5). The Header area 801 further stores an attribute data existence/nonexistence flag of the additional drawing.

An additional drawing area 802 stores the PDL command of the additional drawing generated in step S403 as the attribute data of the additional drawing. A document area 803 stores the PDL command of the print target document generated in step S402.

Returning to the description of the flow chart of FIG. 3, in step S405, the print processing unit 303 transmits a print job 800 illustrated in FIG. 7 to the system spooler 204 and ends the processing illustrated in the flow chart. The system spooler 204 transmits the print job 800 received from the print processing unit 303 of the printer driver 203 to the printer 150.

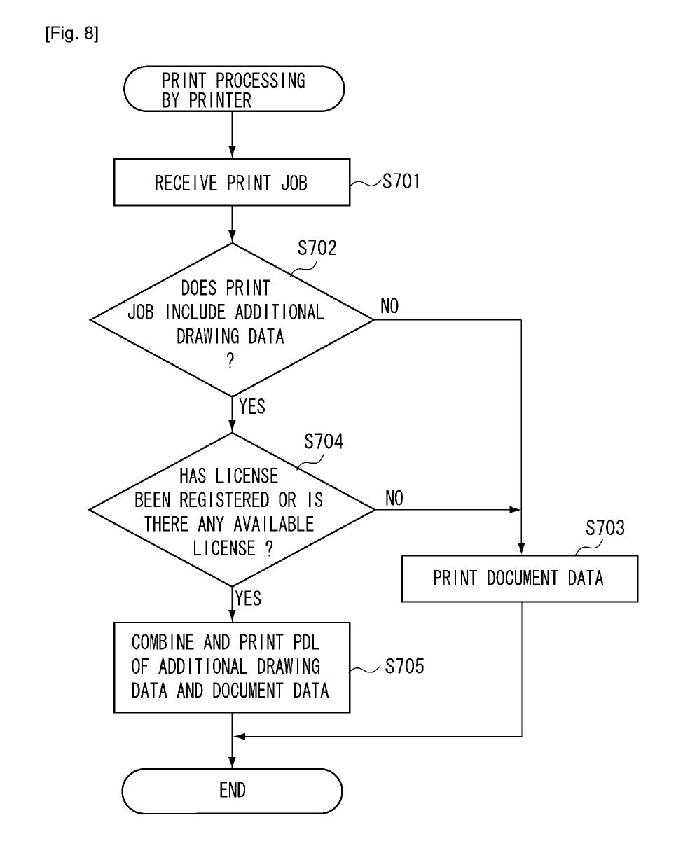

Referring to a flow chart illustrated in FIG. 8, printing processing executed by the printer 150 according to the first exemplary embodiment of the present invention is described. FIG. 8 is a flow chart illustrating the printing processing executed by the printer 150 according to the first exemplary embodiment. A program of the printer 150 associated with the processing in the flow chart in FIG. 8 is stored in the HD 21 of the printer 150 and read by the RAM 13 to be executed by the CPU 12.

In step S701, the print job receiving unit 151 of the printer 150 receives the print job transmitted from the system spooler 204 of FIG. 3. In step S702, the print job control unit 152 determines whether the attribute data of the additional drawing (PDL command of the additional drawing) is included in the received print job based on the attribute data existence/nonexistence flag of the additional drawing in the Header area 801 of the print job received in step S701. When it is determined in step S702 that the attribute data of the additional drawing (PDL command of the additional drawing) is not included in the print job (NO in step S702), the print job control unit 152 proceeds with the processing to step S703 without performing the additional drawing control.

In step S703, the print job control unit 152 transmits the PDL command (print data) of the print target document to the print processing unit 156. The print processing unit 156 receives the PDL command (print data) of the print target document from the print job control unit 152 and prints the received data. Accordingly, a print result as the document illustrated in FIG. 4 is obtained.

When it is determined in step S702 that the attribute data of the additional drawing (PDL command of the additional drawing) is included in the print job (YES in step S702), the print job control unit 152 proceeds with the processing to step S704. In step S704, the additional drawing control unit 153 determines via the license management unit 154 whether the print job is generated by the licensed host computer.

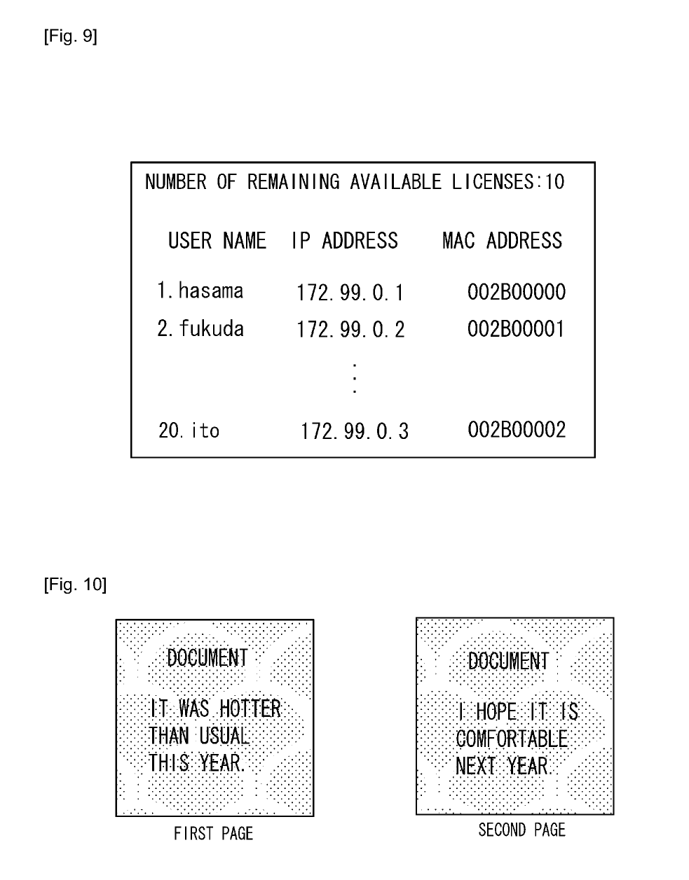

The license management unit 154 collates the unique information included in the print job (FIG. 5) with the information registered in the license DB 155 (FIG. 9). FIG. 9 illustrates an example of the license DB 155 according to the present exemplary embodiment. As illustrated in FIG. 9, the unique information including the “user name”, “MAC address” and “IP address” is registered (stored) in the license DB 155. Further, a number of remaining available licenses is also registered (stored) in the license DB 155. An administrator of the printer 150 may register in advance the unique information (license) in the license DB 155 from the operation unit 20 of the printer 150 or the information processing apparatus via the network 400. The number of remaining available licenses may be previously registered by a serviceperson in the license DB 155 via the operation unit 20 according to a number of purchased licenses, or may be registered in the license DB 155 before shipment. In that case, a customer is asked to pay a predetermined amount of money to purchase a CD-ROM in which a whole set of programs according to the present exemplary embodiment are stored. The customer may purchase a license key which is a predetermined symbolic sequence from a dealer, so that the number of remaining available licenses may be automatically registered in the license DB 155 after the customer inputs the purchased license key to an installer when the customer initially installs the programs.

The license management unit 154 determines whether the unique information included in the print job is registered in the license DB 155, and transmits a determination result to the additional drawing control unit 153. When the unique information is registered in the license DB 155, the license management unit 154 notifies the additional drawing control unit 153 of the presence of any registered license.

When the unique information is not registered in the license DB 155 and there is any remaining available license (there is at least one remaining license), the license management unit 154 registers the unique information in the license DB 155. The license management unit 154 decrements the number of remaining available licenses by “1”. Further, the license management unit 154 notifies the additional drawing control unit 153 of the presence of any remaining available license.

When the unique information is not registered in the license DB 155 and there is no remaining available license (there is at least one remaining license), the license management unit 154 notifies the additional drawing control unit 153 of no registered license.

In step S704 (FIG. 8), the additional drawing control unit 153 determines whether any license is registered or there is any remaining license still available based on the determination result transmitted from the license management unit 154.

When there is any registered license or any remaining license still available (YES in step S704), the additional drawing control unit 153 determines that the host computer which generated the print job is granted the license for the additional drawing function. Then, the additional drawing control unit 153 advances the processing to step S705.

In step S705, the additional drawing control unit 153 generates a combined PDL command by combining the PDL command in the document area 803 (PDL command of the print target document) with the PDL command in the additional drawing area 802 (PDL command of the additional drawing). Then, the additional drawing control unit 153 transmits the generated combined PDL command to the print job control unit 152. The print job processing unit 156 receives the combined PDL command from the print job control unit 152 and prints the received data. Accordingly, a print result as a document with the additional drawing illustrated in FIG. 10 is obtained. The document with the additional drawing in FIG. 10 is formed by combining the print target document in FIG. 4 with the additional drawing in FIG. 6. In other words, an effect of the additional drawing function can be exerted.

FIG. 10 illustrates an example of a printed result of the document with the additional drawing according to the present exemplary embodiment. On the other hand, when there is no registered license and no remaining license still available (NO in step S704), the additional drawing control unit 153 determines that the host computer which generated the print job is not granted the license for the additional drawing function. Then, the additional drawing control unit 153 advances the processing to step S703 without performing the additional drawing controlling. Accordingly, the print target document as illustrated in FIG. 4 is printed in step S703. In this case, the effect of the additional drawing function cannot be exerted.

When a print job is generated by the host computer which is granted the license for the additional drawing function and the document illustrated in FIG. 4 is processed according to FIGS. 3 and 8 as described above, the PDL command of the document and the PDL command of the additional drawing are combined with each other, and the result illustrated in FIG. 10 can be obtained. On the other hand, when a print job is generated by the host computer which is not granted the license for the additional drawing function, the PDL command of the document and the PDL command of the additional drawing are not combined, and the result illustrated in FIG. 4 is obtained. Thus, the printer 150 according to the present exemplary embodiment cannot gain the effect of the additional function unless the license for the additional function is granted when the printing is executed even after the additional function is installed in the host computer. The printer 150, however, can gain the effect of the additional function as far as the host computer has the license for the additional function when the printing is executed.

### Example 2

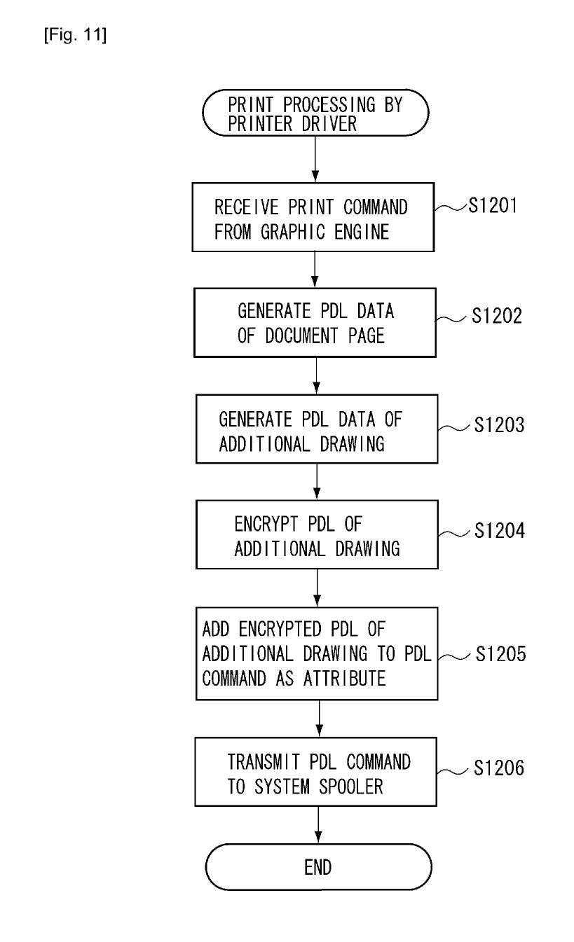

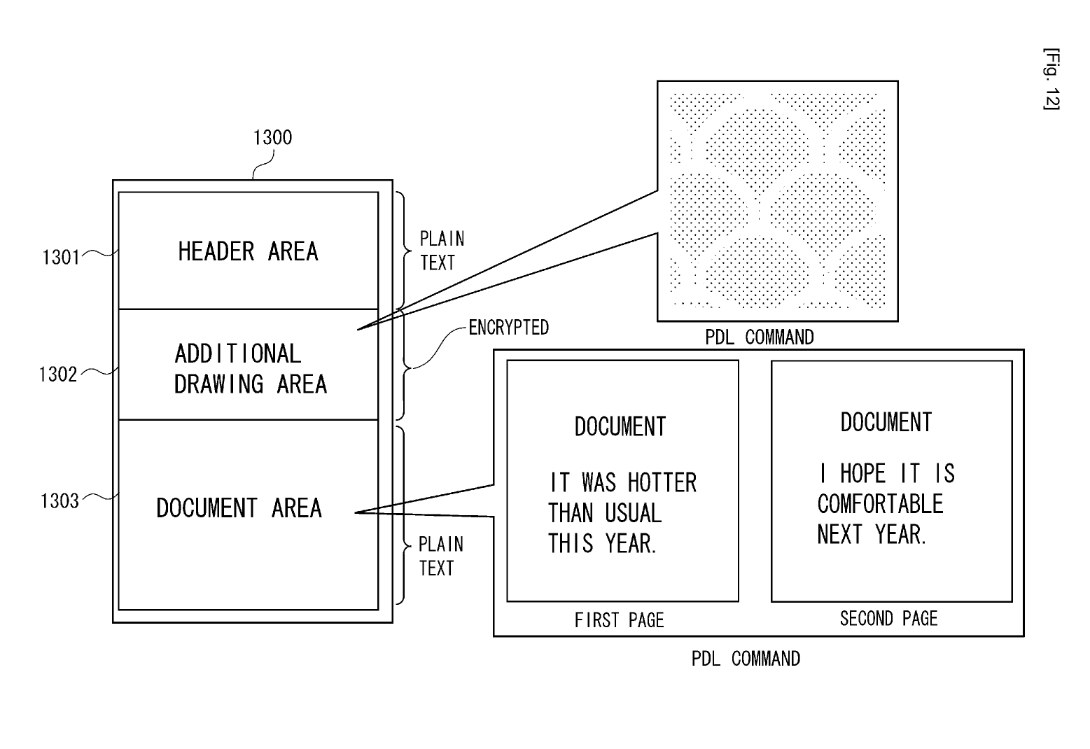

In the first exemplary embodiment, the PDL of the additional drawing is directly transmitted to the system spooler 204 in a form of a plain text in the printing processing executed by the printer driver 203. If the additional drawing itself represents valuable data, however, it is necessary to protect the additional drawing data. In a second exemplary embodiment of the present invention, therefore, printing processing in which the PDL command of the additional drawing is encrypted will be described referring to a flow chart illustrated in FIG. 11.

FIG. 11 is a flow chart illustrating printing processing executed by the printer driver 203 according to the second exemplary embodiment. A program of the printer driver 203 associated with the processing illustrated in the flow chart is stored in the HD 11 of the computer and read by the RAM 2 to be executed by the CPU 1.

Steps S1201 to S1203 illustrated in FIG. 11 are similar to steps S401 to S403 of FIG. 3, and these steps will not be described to avoid redundant description. In step S1204 of FIG. 11, the print processing unit 303 encrypts the PDL command of the additional drawing generated in step S1203. In step S1205, the print processing unit 303 adds the PDL command of the additional drawing encrypted in step S1204 to the print job generated in step S1202 as the attribute data.

FIG. 12 illustrates an example of the print job to which the encrypted PDL command of the additional drawing is added as the attribute data according to the second exemplary embodiment of the present invention. In FIG. 12, a Header area 1301 stores the document print command received in step S1201 and the unique information of the host computer added in step S1202 (FIG. 5). The Header area 1301 further stores an attribute data existence/nonexistence flag of the additional drawing.

In an additional drawing area 1302, the PDL command of the additional drawing encrypted in step S1204 is stored. In a document area 1303, the PDL command of the print target document generated in step S1202 is stored. Information to be stored in the Header area 1301 and the PDL command of the print target document to be stored in the document area 1303 are respectively stored in the form of a plain text.

Returning to the description of the flow chart of FIG. 11, in step S1205, the print processing unit 303 transmits a print job 1300 illustrated in FIG. 12 to the system spooler 204 and ends the processing illustrated in the flow chart. The system spooler 204 transmits the print job 1300 received from the print processing unit 303 of the printer driver 203 to the printer 150.

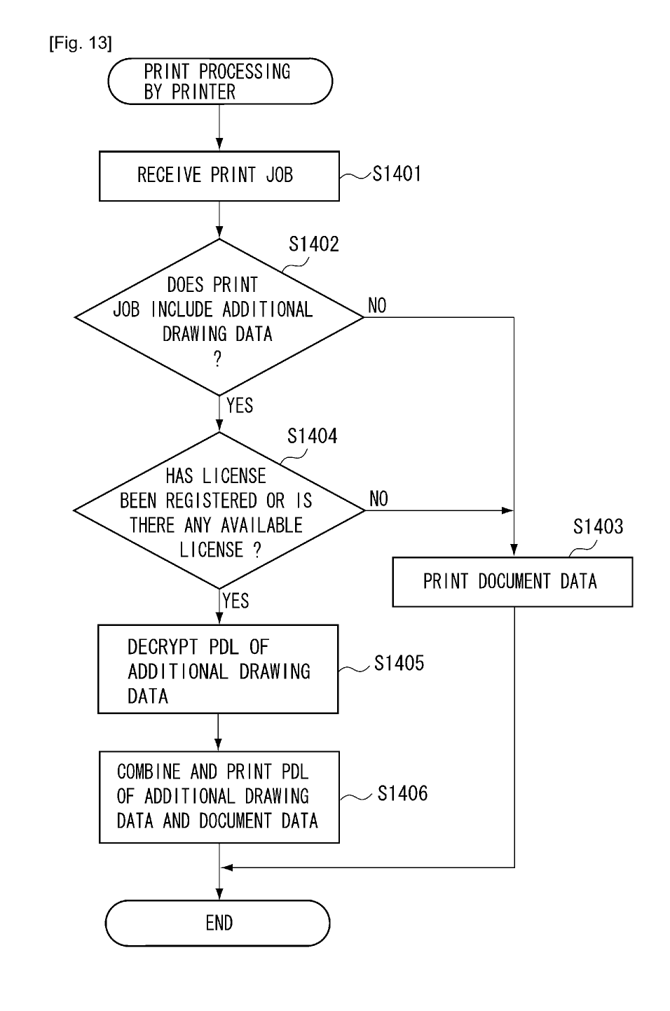

Referring to a flow chart illustrated in FIG. 13, printing processing executed by the printer 150 according to the second exemplary embodiment of the present invention is described. FIG. 13 is flow chart illustrating the printing processing executed by the printer 150 according to the second exemplary embodiment. A program of the printer 150 associated with the processing in the flow chart in FIG. 13 is stored in the HD 21 of the printer 150 and read by the RAM 13 to be executed by the CPU 12. Steps S1401 to 1404 of FIG. 13 are similar to steps S701 to S704 of FIG. 8, and these steps will not be described to avoid redundant description.

When it is determined in step S1404 of FIG. 13 there is any registered license or any remaining license still available (YES in step S1404), the additional drawing control unit 153 determines that the host computer which generated the print job is granted the license for the additional drawing function. Then, the additional drawing control unit 153 advances the processing to step S1405.

In step S1405, the additional drawing control unit 153 decrypts the encrypted PDL command of the additional drawing which is stored in the additional drawing area 1302 of the print job. In step S1406, the additional drawing control unit 153 generates a combined PDL command by combining the PDL command in the document area 803 of the print job (PDL command of the print target document) with the PDL command of the additional drawing decrypted in step S1405. Then, the additional drawing control unit 153 transmits the generated combined PDL command to the print job control unit 152. The print job processing unit 156 receives the combined PDL command from the print job control unit 152 and prints the received data. Accordingly, a print result as a document with the additional drawing illustrated in FIG. 10 is obtained. The document with the additional drawing in FIG. 10 is formed by combining the print target document in FIG. 4 with the additional drawing in FIG. 6. In other words, an effect of the additional drawing function can be exerted.

On the other hand, when it is determined in step S1404 that there is no registered license and no remaining license still available (NO in step S1404), the additional drawing control unit 153 determines that the host computer which generated the print job is not granted the license for the additional drawing function. Then, the additional drawing control unit 153 advances the processing to step S1403 without performing the additional drawing controlling. Accordingly, the print target document as illustrated in FIG. 4 is printed in step S1403. In this case, the effect of the additional drawing function cannot be exerted.

When a print job is generated by the host computer which is granted the license for the additional drawing function and the document illustrated in FIG. 4 is processed according to FIGS. 11 and 13 as described above, the PDL command of the document and the PDL command of the additional drawing are combined with each other, and the result illustrated in FIG. 10 can be obtained. On the other hand, when a print job is generated by the host computer which is not granted the license for the additional drawing function, the PDL command of the document and the PDL command of the additional drawing are not combined, and the result illustrated in FIG. 4 is obtained. Thus, the printer 150 according to the present exemplary embodiment cannot gain the effect of the additional function unless the license for the additional function is granted when the printing is executed even after the additional function is installed in the host computer. The printer 150, however, can gain the effect of the additional function as far as the host computer has the license for the additional function when the printing is executed.

According to the present exemplary embodiment, when the additional drawing itself represents valuable data, the additional drawing data can be protected and any unauthorized use of the additional drawing can be prevented.

### Example 3

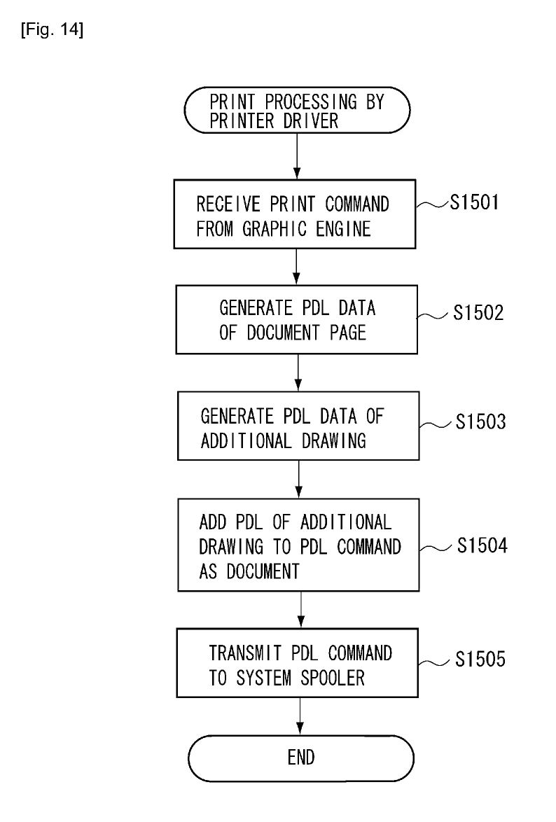

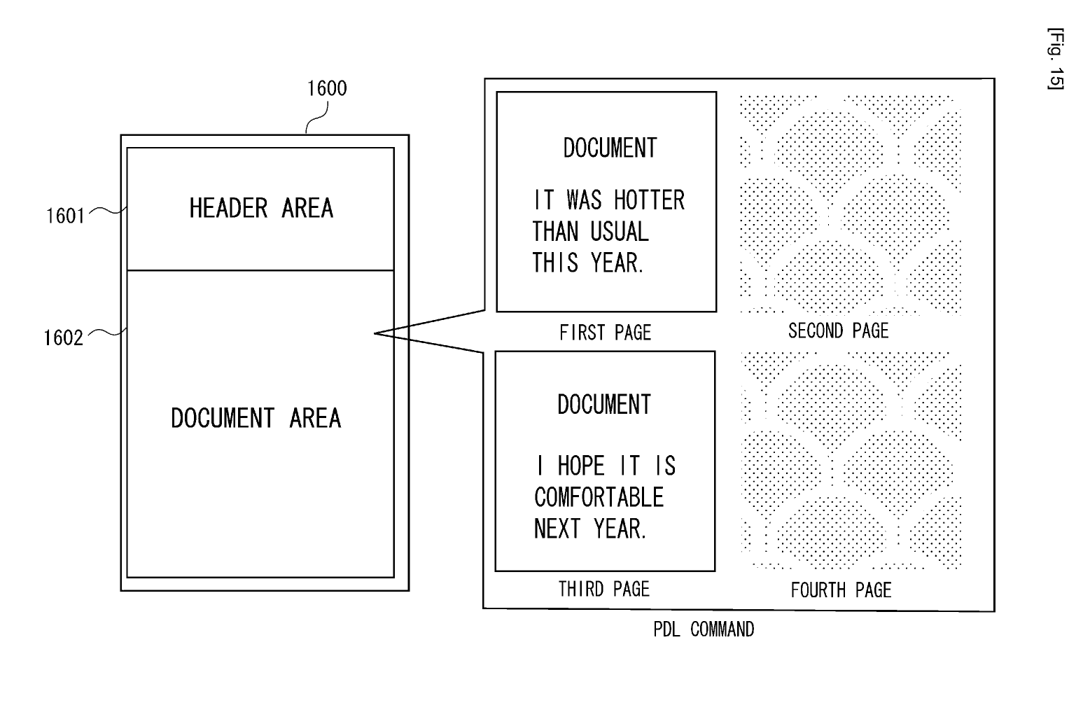

In the first exemplary embodiment, the additional drawing is added to the print job as the attribute data in the printing processing executed by the printer driver 203. In a third exemplary embodiment of the present invention, printing processing in which the additional drawing is used as a page of the document data will be described referring to a flow chart illustrated in FIG. 14.

FIG. 14 is a flow chart illustrating the printing processing executed by the printer driver 203 according to the third exemplary embodiment. A program of the printer driver 203 associated with the processing illustrated in the flow chart is stored in the HD 11 of the computer and read by the RAM 2 to be executed by the CPU 1.

Steps S1501 to S1503 illustrated in FIG. 14 are similar to steps S401 to S403 of FIG. 3, and these steps will not be described to avoid redundant description. In step S1504 of FIG. 14, the print processing unit 303 adds the PDL command of the additional drawing generated in step S1203 to a print job 1600 generated in step S1502 as a page of the document data.

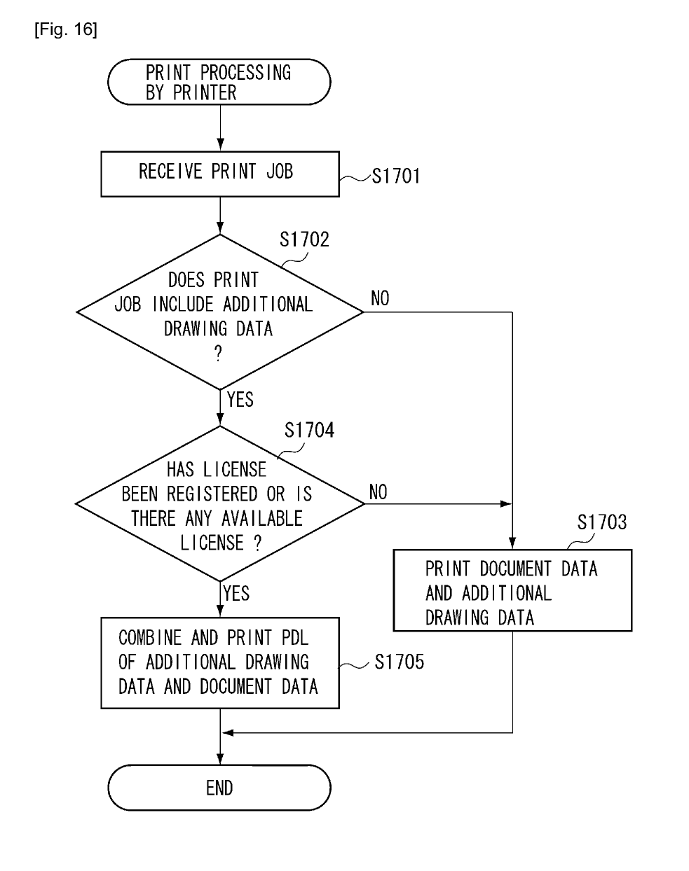

FIG. 15 illustrates an example of a print job to which the PDL command of the additional drawing is added as a page of the PDL command of the print target document according to the third exemplary embodiment. In FIG. 15, a Header area 1601 stores the document print command received in step S1501 of FIG. 14 and the unique information of the host computer added in step S1502 (FIG. 5). The Header area 1601 further stores a document data existence/nonexistence flag of the additional drawing.

In a document area 1602, each page of the PDL command of the additional drawing generated in step S1503 is stored subsequent to each page of the PDL command of the document (print target document) generated in step S1502. It is not necessary to alternately arrange the PDLs of the print document and the additional drawing.

Returning to the description of the flow chart of FIG. 14, in step S1505, the print processing unit 303 transmits the print job 1600 of FIG. 15 to the system spooler 204 and ends the processing illustrated in the flow chart. The system spooler 204 transmits the print job 1600 received from the print processing unit 303 of the printer driver 203 to the printer 150.

Hereinafter, printing processing executed by the printer 150 according to the third exemplary embodiment of the present invention is described referring to a flow chart illustrated in FIG. 16. FIG. 16 is a flow chart illustrating the printing processing executed by the printer 150 according to the third exemplary embodiment. A program of the printer 150 associated with the processing in the flow chart in FIG. 8 is stored in the HD 21 of the printer 150 and read by the RAM 13 to be executed by the CPU 12.

In step S1701, the print job receiving unit 151 of the printer 150 receives the print job transmitted from the system spooler 204 of FIG. 3. In step S1702, the print job control unit 152 determines whether the document data of the additional drawing (PDL of the additional drawing) is included in the received print job based on the attribute data existence/nonexistence flag of the additional drawing in the Header area 1601 of the print job received in step S1701.

When the print job control unit 152 determines in step S1702 that the document data of the additional drawing (PDL command of the additional drawing) is not included in the print job (NO in step S1702), the print job control unit 152 proceeds with the processing to step S1703 without performing the additional drawing control.

In step S1703, the print job control unit 152 transmits the PDL command (print data) in the document area 1602 of the print job received in step S1701 to the print processing unit 156. The print processing unit 156 receives the PDL command (print data) from the print job control unit 152 and prints the received data. Accordingly, print results as the document illustrated in FIG. 4 and the additional drawing illustrated in FIG. 6 are obtained.

When the print job control unit 152 determines in step S1702 that the document data of the additional drawing (PDL of the additional drawing) is included in the print job (YES in step S1702), the print job control unit 152 advances the processing to step S1704.

In step S1704, the additional drawing control unit 153 determines via the license management unit 154 whether the print job is generated by the licensed host computer.

When there is any registered license or any remaining license still available (YES in step S1704), the additional drawing control unit 153 determines that the host computer which generated the print job is granted the license for the additional drawing function. Then, the additional drawing control unit 153 advances the processing to step S1705.

In step S1705, the additional drawing control unit 153 combines the PDL command of the print target document in the document area 1602 of the print job with the PDL command of the additional drawing added as the document page and generates a combined PDL command. When each page of the PDL command of the additional drawing is stored subsequent to each page of the PDL command of the print target document, the combined PDL command is generated such that the PDL commands of page 1 and page 2 are combined or the PDL commands of an odd-numbered page and an even-numbered page are combined. Then, the additional drawing control unit 153 transmits the generated combined PDL command to the print job control unit 152. The print job processing unit 156 receives the combined PDL command from the print job control unit 152 and prints the received data. Accordingly, a print result as a document with the additional drawing illustrated in FIG. 10 is obtained. The document with the additional drawing in FIG. 10 is formed by combining the print target document in FIG. 4 with the additional drawing in FIG. 6. In other words, an effect of the additional drawing function can be exerted.

On the other hand, when there is no registered license and no remaining license still available (NO in step S1704), the additional drawing control unit 153 determines that the host computer which generated the print job is not granted the license for the additional drawing function. Then, the additional drawing control unit 153 advances the processing to step S1703 without performing the additional drawing controlling. Accordingly, in step S1703, the print target document of FIG. 4 and the additional drawing of FIG. 6 are separately obtained as a printed result. In this case, the effect of the additional drawing function cannot be exerted.

When a print job is generated by the host computer which is granted the license for the additional drawing function and the document illustrated in FIG. 4 is processed according to FIGS. 14 and 16 as described above, the result illustrated in FIG. 10 can be obtained. On the other hand, when a print job is generated by the host computer which is not granted the license for the additional drawing function, the print results of FIGS. 4 and 6 can be obtained. Thus, the printer 150 according to the present exemplary embodiment cannot gain the effect of the additional function unless the license for the additional function is granted when the printing is executed even after the additional function is installed in the host computer. The printer 150, however, can gain the effect of the additional function as far as the host computer has the license for the additional function when the printing is executed.

### Example 4

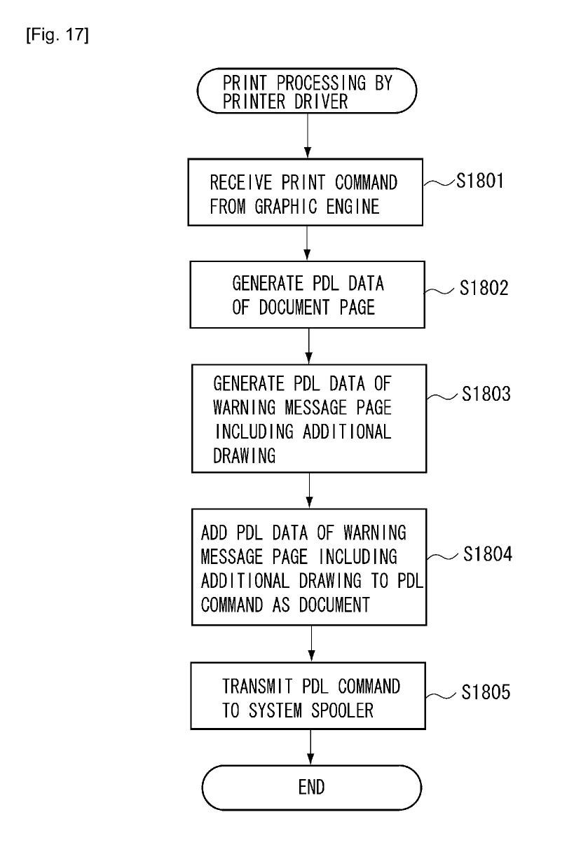

In the first exemplary embodiment, the additional drawing is added to the print job as the attribute data in the printing processing executed by the printer driver 203. In a fourth exemplary embodiment of the present invention, printing processing in which a warning message with the additional drawing is handled as a page of the document data will be described referring to a flow chart illustrated in FIG. 17.

FIG. 17 is a flow chart illustrating printing processing executed by the printer driver 203 according to the fourth exemplary embodiment. A program of the printer driver 203 associated with the processing illustrated in the flow chart is stored in the HD 11 of the computer and read by the RAM 2 to be executed by the CPU 1.

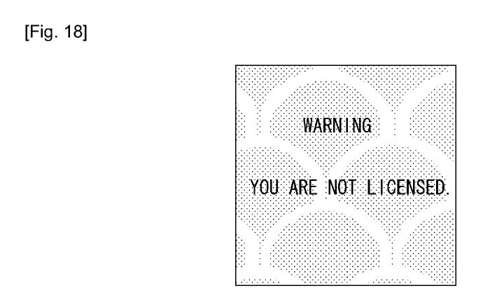

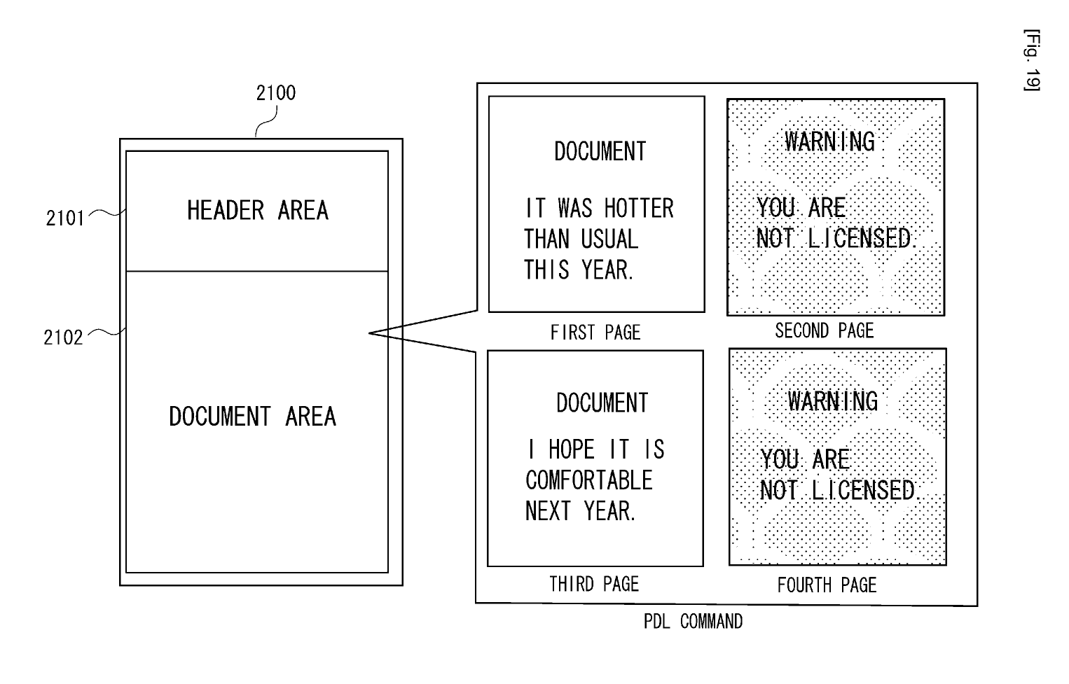

Steps S1801 and S1802 of FIG. 17 are similar to steps S401 and S402 of FIG. 3, and these steps will not be described to avoid redundant description. In steps S1803 of FIG. 17, the additional drawing generation unit 302 generates a PDL command of a warning message with the additional drawing. In the present exemplary embodiment, a PDL command of a warning message with the copy-forgery-inhibited pattern illustrated in FIG. 18 is generated as an example of the warning message with the additional drawing.

FIG. 18 illustrates an example of the warning message with the additional drawing according to the fourth exemplary embodiment. In step S1804, the print processing unit 303 adds the PDL command of the warning message with the additional drawing generated in step S1803 to a print job 2100 (FIG. 19) generated in step S1802 as a page of the document data.

FIG. 19 illustrates an example of the print job to which the PDL command of the warning message with the additional drawing is added as a page of the document data according to the fourth exemplary embodiment of the present invention. In FIG. 19, a Header area 2101 stores the document print command received in step S1801 and the unique information of the host computer added in step S1802 (FIG. 5). The Header area 2101 further stores a document data existence/nonexistence flag of the additional drawing.

In a document area 2102, each page of the PDL command of the warning message with the additional drawing generated in step S1803 is stored subsequent to each page of the PDL command of the document (print target document) generated in step S1802. It is not necessary to alternately arrange the PDLs of the print document and the additional drawing.

Returning to the description of the flow chart of FIG. 17, in step S1805, the print processing unit 303 transmits the print job 2100 of FIG. 19 to the system spooler 204, and ends the processing illustrated in the flow chart. The system spooler 204 transmits the print job 2100 received from the print processing unit 303 of the printer driver 203 to the printer 150.

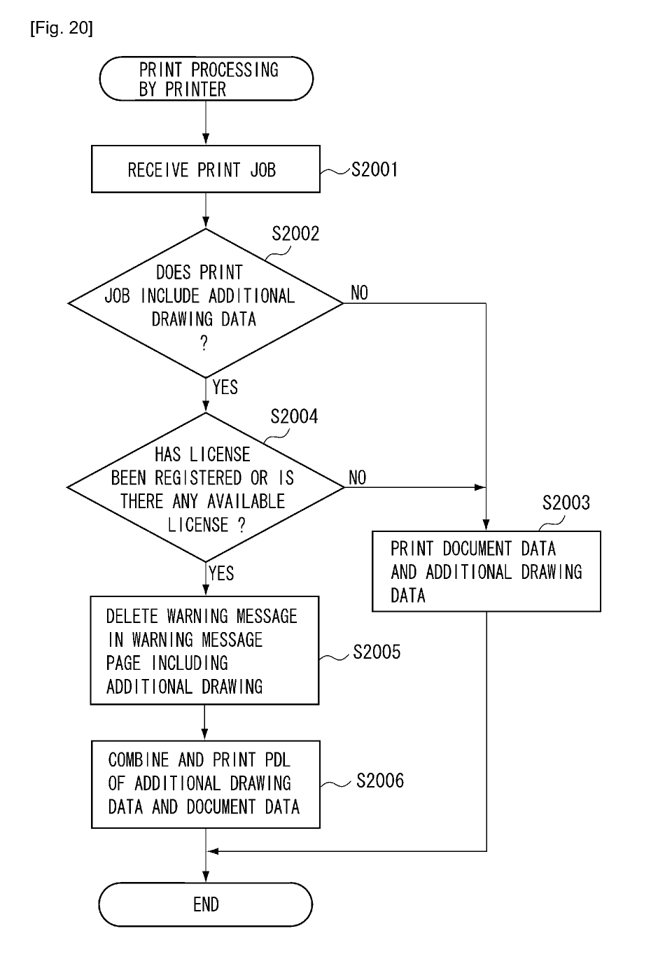

Referring to a flow chart illustrated in FIG. 20, printing processing executed by the printer 150 according to the fourth exemplary embodiment is described. FIG. 20 is a flow chart illustrating the printing processing executed by the printer 150 according to the fourth exemplary embodiment. A program of the printer 150 associated with the processing in the flow chart in FIG. 8 is stored in the HD 21 of the printer 150 and read by the RAM 13 to be executed by the CPU 12.

In step S2001, the print job receiving unit 151 of the printer 150 receives the print job transmitted from the system spooler 204 of FIG. 3. In step S2002, the print job control unit 152 determines whether the attribute data of the additional drawing (PDL of the additional drawing) is included in the received print job based on the document data existence/nonexistence flag of the additional drawing in the Header area 2101 of the print job received in step S2001.

When the print job control unit 152 determines in step S2002 that the document data of the additional drawing (PDL command of the additional drawing) is not included in the print job (NO in step S2002), the print job control unit 152 proceeds with the processing to step S2003 without performing the additional drawing control.

In step S2003, the print job control unit 152 transmits the PDL command (print data) in the document area 2102 of the print job received in step S2001 to the print processing unit 156. The print processing unit 156 receives the PDL command (print data) from the print job control unit 152 and prints the received data. Accordingly, print results as the document illustrated in FIG. 4 and the additional drawing illustrated in FIG. 6 are obtained.

When the print job control unit 152 determines in step S2002 that the document data of the additional drawing (PDL of the additional drawing) is included in the print job (YES in step S2002), the print job control unit 152 advances the processing to step S2004.

In step S2004, the additional drawing control unit 153 determines via the license management unit 154 whether the print job is generated by the licensed host computer.

When there is any registered license or any remaining license still available (YES in step S2004), the additional drawing control unit 153 determines that the host computer which generated the print job is granted the license for the additional drawing function. Then, the additional drawing control unit 153 advances the processing to step S2005.

In step S2005, the additional drawing control unit 153 deletes the warning message from the page of the PDL command of the warning message with the additional drawing in the document area 2102 of the print job and generates a page of the PDL command of the additional drawing. When each page of the PDL command of the warning message with the additional drawing is stored subsequent to each page of the PDL command of the print target document, for example, the warning message is deleted from even-numbered pages of the PDL command, and the pages of the PDL command of the additional drawing are then generated.

In step S2006, the additional drawing control unit 153 combines the PDL command of the print target document in the document area 2102 of the print job with the PDL command of the additional drawing generated in step S2005, so that a combined PDL command is generated. When each page of the PDL command of the warning message with the additional drawing is stored subsequent to each page of the PDL command of the print target document, the combined PDL command is generated such that the PDL commands of page 1 and page 2 are combined or the PDL commands of an odd-numbered page and an even-numbered page are combined. Then, the additional drawing control unit 153 transmits the generated combined PDL command to the print job control unit 152. The print job processing unit 156 receives the combined PDL command from the print job control unit 152 and prints the received data. Accordingly, a print result as a document with the additional drawing illustrated in FIG. 10 is obtained. The document with the additional drawing in FIG. 10 is formed by combining the print target document of FIG. 4 with the additional drawing of FIG. 6 obtained by deleting the warning message from the warning message with the additional drawing illustrated in FIG. 18. In other words, an effect of the additional drawing function can be exerted.

On the other hand, when there is no registered license and no remaining license still available (NO in step S2004), the additional drawing control unit 153 determines that the host computer which generated the print job is not granted the license for the additional drawing function. Then, the additional drawing control unit 153 advances the processing to step S2003 without performing the additional drawing controlling. Accordingly, in step S2003, the print document of FIG. 4 and the warning message with the additional drawing of FIG. 18 are separately obtained as a printed result. In this case, the effect of the additional drawing function cannot be exerted.

When a print job is generated by the host computer which is granted the license for the additional drawing function and the document illustrated in FIG. 4 is processed according to FIGS. 17 and 20 as described above, the result illustrated in FIG. 10 can be obtained. On the other hand, when a print job is generated by the host computer which is not granted the license for the additional drawing function, the print results of FIGS. 4 and 18 can be obtained. Thus, the printer 150 according to the present exemplary embodiment cannot gain the effect of the additional function unless the license for the additional function is granted when the printing is executed even after the additional function is installed in the host computer. The printer 150, however, can gain the effect of the additional function as far as the host computer has the license for the additional function when the printing is executed. According to the present exemplary embodiment, when the additional drawing itself represents valuable data, the additional drawing data is printed with the warning message and any unauthorized use of the additional drawing can be prevented.

In the above described exemplary embodiments, the copy-forgery-inhibited pattern is used as the additional drawing. The additional drawing, however, is not particularly limited, and any of barcodes, two-dimensional codes, digital watermark, and low visibility barcodes (LVBC) can be used.

The description of the fourth exemplary embodiment is based on the PDL command of the warning message, however, any kind of warning message may be used. For example, image data depicting a warning message can be used in place of the PDL command of the warning message. In the above described exemplary embodiments, the administrator of the printer 150 registers the unique information in the license DB 155 (license registration) in advance using the operation unit 20 of the printer 150 or using the information processing apparatus via the network 400. Similarly, the administrator of the printer 150 deletes the unique information from the license DB 155 (license deletion) in advance using the operation unit 20 of the printer 150 or using the information processing apparatus via the network 400.

Below is given a consideration on a network provided with a plurality of printers of the same model. There are the following possible embodiments.

Embodiment 1: Each of the printers independently manages its license in the license DB 155. If there are x number of PCs and y number of printers, and it is intended that all of the PCs and all of the printers use the additional drawing function, a user needs to purchase x*y number of licenses.

Embodiment 2: A plurality of printers share their data registered in the license DB 155. When the data of one of the printers registered in the license DB 155 is updated, for example, the other printers are notified of the updated registered data, and the data of the other printers in the license DB are similarly updated. If there are x number of PCs and y number of printers, and it is intended that all of the PCs and all of the printers use the additional drawing function, a user needs to purchase x number of licenses. These embodiments are just a few examples, and other embodiments can be employed.

In the exemplary embodiments described above, the printer manages the license of the additional drawing function. However, the additional function of the printer driver is not limited to the additional drawing function, and other additional functions can be further installed.

For example, when a received print job includes a command for using an additional function, the CPU 12 of the printer 150 determines whether the print job is generated by an information processing apparatus which has a license for the additional function. When it is determined that the print job is generated by the information processing apparatus which has the license, the CPU 12 executes the command for using the additional function included in the print job and outputs an image. On the other hand, when it is determined that the print job is generated by an information processing apparatus which does not have the license, the CPU 12 outputs an image without executing the command for using the additional function included in the print job. The command for using the additional command may be encrypted.

In the case of a plurality of additional functions, a license for each of the additional functions is registered in the license DB 155, and the license management unit 154 separately manages the licenses for the additional functions.

According to the exemplary embodiments of the present invention described above, the additional function can be effectively exerted when the printing processing is performed as far as the license thereof is ensured, without providing a license server and without restricting the installation of the additional drawing function in the printer driver. Moreover, the effect of the additional function can be controlled not to be provided unless the license for the additional function is granted when the printing is executed.

The present invention can also be realized by executing the following process. That is, in the process, a software (program) that realizes the functions of the above-described embodiments is supplied to the system or apparatus via a network or a recording medium of various types, and then a computer of the system or apparatus (or devices such as CPU or MPU) reads out the program and executes it. In such a case, the program and the recording medium where the program is stored are included in the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2009-036908 filed Feb. 19, 2009, which is hereby incorporated by reference herein in its entirety.

1. An image forming apparatus which outputs an image based on a print job received from an information processing apparatus, the image forming apparatus comprising:
a determining unit configured to determine whether a received print job is generated by an information processing apparatus which has a license for an additional drawing function when the received print job includes print data of an additional drawing for printing the additional drawing on a print target document; and
a control unit configured to perform control to output an image by combining print data of the print target document included in the print job with the print data of the additional drawing when the determining unit determines that the received print job is generated by the information processing apparatus which has the license.

2. The image forming apparatus according to claim 1, wherein the control unit outputs the image using the print data of the print target document without combining the print data of the print target document with the print data of the additional drawing when the determining unit determines that the received print job is generated by an information processing apparatus which does not have the license.

3. The image forming apparatus according to claim 1,
wherein the print data of the additional drawing is encrypted, and the image forming apparatus further comprising a decrypting unit configured to decrypt the print data of the additional drawing when the determining unit determines that the received print job is generated by the information processing apparatus which has the license.

4. The image forming apparatus according to claim 1,
wherein the print data of the additional drawing is added to the print job as an attribute data.

5. The image forming apparatus according to claim 1,
wherein the print data of the additional drawing is added to the print job as print data of a page in the print data of the print target document.

6. The image forming apparatus according to claim 1,
wherein the print data of the additional drawing includes print data of a warning message, and
the image forming apparatus further comprising a deleting unit configured to delete the print data of the warning message from the print data of the additional drawing when the determining unit determines that the received print job is generated by the information processing apparatus which has the license.

7. The image forming apparatus according to claim 1,
wherein the print data of the additional drawing is print data of a copy-forgery-inhibited pattern, a barcode, a digital watermark, or a low visibility barcode to be additionally drawn on the print target document.

8. The image forming apparatus according to claim 1,
wherein the print job including the print data of the additional drawing is generated by an information processing apparatus in which the additional drawing function is installed as an additional function of a printer driver.

9. The image forming apparatus according to claim 1,
wherein the print job includes unique information of the information processing apparatus which generates the print job, and
the image forming apparatus further comprising a storage unit configured to store the unique information of the information processing apparatus which has the license,
wherein the determining unit determines that the print job is generated by the information processing apparatus which has the license when the unique information included in the print job is stored in the storage unit.

10. The image forming apparatus according to claim 9,
wherein when the unique information included in the print job is not stored in the storage unit, the determining unit determines whether the unique information stored in the storage unit equals to preset number of licenses, when the unique information is not yet equal to the number of licenses, the determining unit stores the unique information included in the print job in the storage unit and determines that the print job is generated by the information processing apparatus which has the license, and
when the unique information is equal to the number of licenses, the determining unit determines that the print job is generated by the information processing apparatus which does not have the license.

11. The image forming apparatus according to claim 9,
wherein the unique information is information for uniquely identifying the information processing apparatus or information for uniquely identifying the information processing apparatus and a user using the information processing apparatus.

12. A method for controlling an image forming apparatus which outputs an image based on a print job received from an information processing apparatus, the method comprising:
determining whether a received print job is generated by an information processing apparatus which has a license for an additional drawing function when the received print job includes print data of an additional drawing for printing the additional drawing on a print target document; and
performing control to output an image by combining a print data of the print target document included in the print job with the print data of the additional drawing when the determining unit determines that the received print job is generated by the information processing apparatus which has the license.

13. A computer readable storage medium on which is stored a computer program for making a computer execute a method for controlling an image forming apparatus which outputs an image based on a print job received from an information processing apparatus, the method comprising:
determining whether a received print job is generated by an information processing apparatus which has a license for an additional drawing function when the received print job includes print data of an additional drawing for printing the additional drawing on a print target document; and
performing control to output an image by combining a print data of the print target document included in the print job with the print data of the additional drawing when the determining unit determines that the received print job is generated by the information processing apparatus which has the license.
